(19) United States
(12) Patent Application Publication
(10) Pub. No.: US 2006/0075185 A1
(43) Pub. Date: Apr. 6, 2006

(54) Method for caching data and power conservation in an information handling system

(75) Inventors: Douglas A. Azzarito, Round Rock, TX (US); Peter A. Woytovech, Round Rock, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 10/959,864

(22) Filed: Oct. 6, 2004

(51) Int. Cl. G06F 12/00

(52) U.S. Cl. 711/113; 711/103

(57) ABSTRACT

A method for caching data in an information handling system is disclosed in which write commands issued to the hard disk drive of the computer system are routed to non-volatile cache memory of the computer system if the hard disk drive is in a reduced power state. The non-volatile cache memory may be in the form of flash memory. If the hard disk drive is not in a reduced power state, the write command is transmitted to the hard disk drive.

### TECHNICAL FIELD

The present disclosure relates generally to the computer systems and information handling system, and, more particularly, to a system and method for caching data to improve power conservation in an information handling system.

### BACKGROUND

As the value and use of information continues to increase, individuals and businesses continually seek additional ways to process and store information. One option available to users of information is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary with regard to the kind of information that is handled, how the information is handled, how much information is processed, stored, or communicated, and how quickly and efficiently the information may be processed, stored, or communicated. The variations in information handling systems allow for information handling systems to be general or configured for a specific user or specific use, including such uses as financial transaction processing, airline reservations, enterprise data storage, or global communications. In addition, information handling systems may include a variety of hardware and software components that may be configured to process, store, and communicate information and may include one or more computer systems, data storage systems, and networking systems.

Designers of information handling systems have attempted to manage the amount of power consumed by the system. Limiting power consumption is especially important in portable computer systems, which, when not connected to an A/C power source, will typically draw power from a standalone battery within the portable computer system. One technique for limiting the consumption of power in a computer system involves placing the hard disk drive of the computer system in a reduced power state in which the rotational motor of the hard disk drive does not draw power, thereby halting the rotation of the disks of the hard disk drive. The process of placing the hard disk drive in this reduced power state is sometimes referred to as spinning down the hard disk drive. Once a hard disk drive is spun down, the hard disk drive must be reactivated, or spun up, before data can be read from or written to the drive. Although spinning down a drive may conserver the power resources of the computer system, the process of spinning down and spinning up the drive also consumes power and detracts from the performance of the computer system. If a hard disk drive is spun down and spun up too frequently, the computer system will consume an excessive amount of power spinning the drive up and down, and the performance of the computer system will suffer.

Current operating systems access the hard disk drive so frequently that it is not practical or possible to spin down the hard disk drive. Writes to the hard disk drive are too frequent to permit the hard disk drive to be spun down. Saving or retrieving data from a cache memory is an alternative to accessing data from a hard disk drive. Although data retrieved as a result of reads to the hard disk drive are sometimes saved to cache memory, writes issued by the operating system are not typically saved to a cache memory. Instead, writes issued by the operating system are written periodically or at timed intervals to the hard disk drive to avoid the risk that data corruption could occur if the computer system were to fail at a time when data from uncommitted writes was present in the volatile cache memory of the computer system.

### SUMMARY

In accordance with the present disclosure, a method for caching data in an information handling system in which write commands issued to the hard disk drive of the computer system are routed to non-volatile cache memory in the computer system if the hard disk drive is in a reduced power state. If the hard disk drive is not in a reduced power state, the write command is transmitted to the hard disk drive. The non-volatile cache memory may be flash memory. The method disclosed herein is technically advantageous because it prevents the frequent writes from being transmitted directly to the hard disk drive. As such, because the hard disk drive is not occupied with frequent write commands, the hard disk drive may more easily and efficiently enter a reduced power state or spin down mode according to the existing power reduction algorithms employed by the computer system.

In addition, the method disclosed herein is advantageous because the data integrity and cache coherency of the data saved in the cache is preserved in the event of the failure of the computer system at a time when uncommitted writes reside in the cache. Even if the computer system were to fail at a time when uncommitted data resides in the cache, the cache described herein is non-volatile. When power is returned to the computer system, the uncommitted data will reside in the cache and may be written back to the hard disk drive. As another technical advantage of the method disclosed herein, the method also includes a technique for associating each write or set of data in the cache with a unique hard disk drive. In this manner, if a first hard disk drive of the computer system is exchanged for a second hard disk drive during a power loss or shutdown of the computer system, the data in the cache associated with the first hard disk drive is not written to the second hard disk drive. Before writing data from the cache to a hard disk drive, it is first determined that the uncommitted data is associated with and originally directed to the hard disk drive of the computer system. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A is a diagram of a first embodiment of an information handling system;

FIG. 1B is a diagram of a second embodiment of an information handling system;

FIG. 2 is a flow diagram of a series of method steps for selectively writing data to a cache;

FIG. 3 is a flow diagram of a series of method steps that are performed when a hard disk drive transitions from a reduced power state to a full power state; and

FIG. 4 is a flow diagram of a series of method steps for handling uncommitted writes in cache memory following the return of power to the information handling system.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of non-volatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

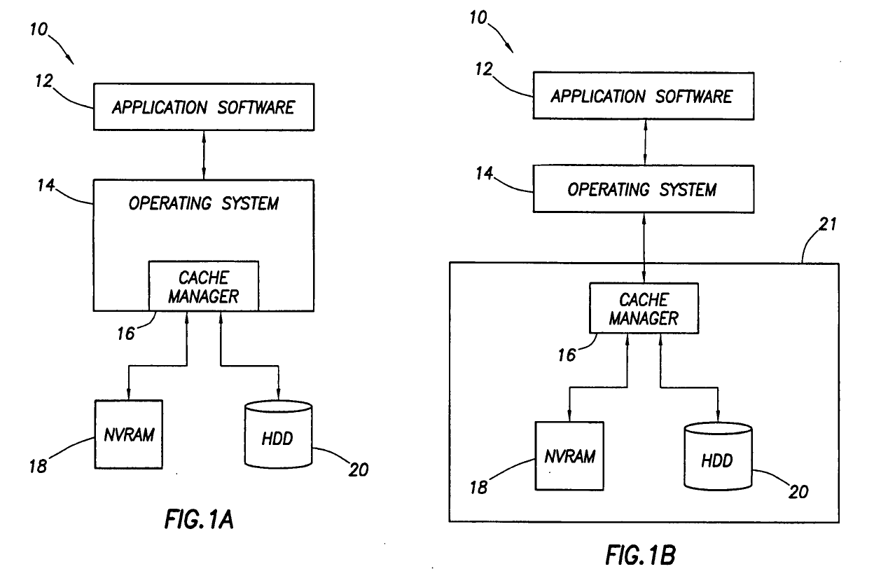

Shown in FIG. 1A is an information handling system or computer system, which is indicated generally at 10. Computer system 10 includes operating system software 14 and a number of instances of application software 12, which run on and are supported by the operating system 14. Operating system 14 includes a cache manager 16, which servers as an interface between the operating system 14 and some of the storage and memory resources of the computer system. As indicated in FIG. 1A, cache manager 16 communicates with the hard disk drive 20 of the computer system. Hard disk drive 20 may include a number of disks or platters, which rotate to facilitate the access to data on the disks or platters. Placing the hard disk drive 20 in a reduced power state, which is sometimes referred to as spinning down the drive, eliminates or reduces the amount of power drawn by the rotational motor of the hard disk drive, thereby reducing the rotation of the disks or platters of the hard disk drive. The cache manager 16 of operating system 14 may also read from and write to a flash memory location 18. Flash memory 18 is non-volatile random access memory (NVRAM). Cache manager 16 is operable to write data to and read data from flash memory 18. In addition, cache manager 16 maintains in flash memory 18 a table of uncommitted data from previous write commands. Uncommitted data is data that exists in flash memory but has not yet been written to hard disk drive 20.

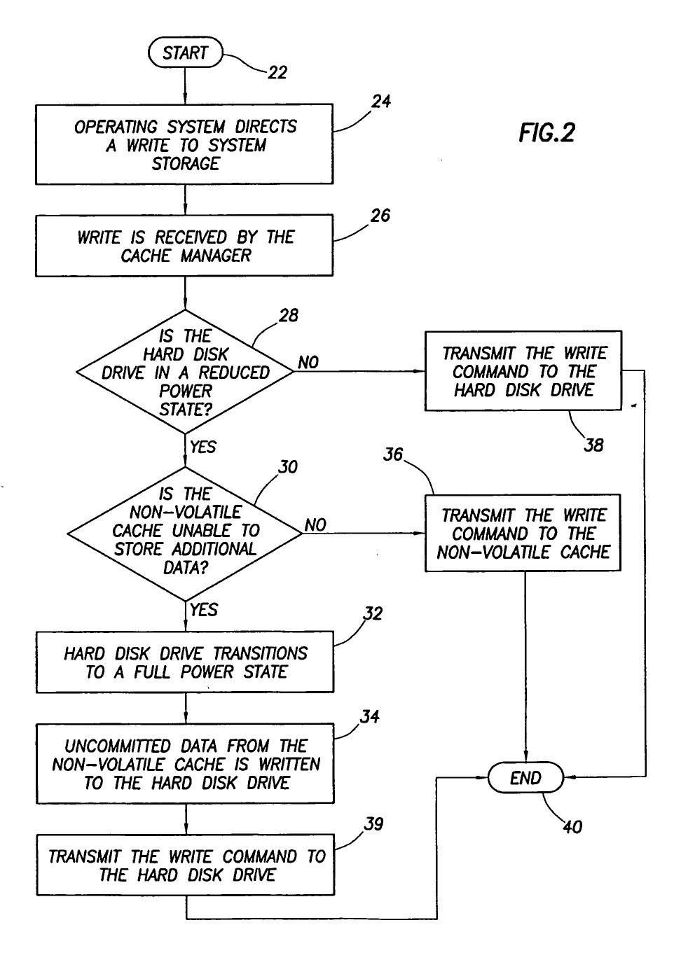

Shown in FIG. 1B is an alternate embodiment of a computer system 10. As compared to the computer system 10 of FIG. 1A, the computer system of FIG. 1B includes a cache manager 16 that is implemented as a storage controller for storage 21 of the computer system. Cache manager 16 of FIG. 2 could be implemented as a software module in a physical storage controller. Cache manager 16 receives each instruction from operating system 14 and is operable to write data to and read data from flash memory 18.

The system and method described herein is advantageous because the cache manager typically copies the data associated with each read to the cache. After a number of reads, the cache is populated with a set of frequently or commonly accessed data, thereby reducing the need for the hard disk drive to be accessed for the reads. Because the hard disk drive is accessed less frequently, the hard disk drive may enter a reduced power state, thereby conserving the power resources of the computer system.

Shown in FIG. 2 is a series of method steps for selectively writing data to a cache, such as flash memory 18, for the purpose of reducing the number of write accesses to the hard disk drive and thereby providing the hard disk drive with longer windows for spinning down or entering a reduced power state. Following the initiation of the method steps at 22, the operating system at step 24 directs a write to system storage, which in this example is hard disk drive 20. At step 26, the write command is received by the cache manager, which may comprise a cache manager module that is integrated with the operating system, as shown in FIG. 1A, or a cache manager that is included as an element of a storage controller, as shown in FIG. 1B. Following the receipt of a write command at step 26, the cache manager determines at step 28 if the hard disk drive is in a reduced power state. If the hard disk drive is not in a reduced power state, the write is transmitted to the hard disk drive at step 38 and the process terminates at step 40.

If it is determined by the cache manager at step 28 that the hard disk drive is in a reduced power state, the cache manager attempts to execute the write command with respect to the cache. At step 30, the cache manager determines if the cache memory includes sufficient space to store the data of the write command. In storing this data, the cache memory cannot overwrite the space previously allocated to uncommitted data of previous write commands, unless the current write is for the same area as a previously allocated write stored in NVRAM. If it is determined that the cache memory does not have sufficient space to store the data of the write command, the uncommitted data of the cache memory must be written back to the hard disk drive. At step 32, the hard disk drive must be reactivated from its reduced power state, and, at step 34, the uncommitted data within the cache must written to the hard disk drive. At step 39, the write command itself is transmitted to the hard drive. Following these steps, the hard disk drive, which has exited its reduced power state, can return to a reduced power state in accordance with its power management algorithm. Following step 39, the flow diagram conclude at step 40.

If it is determined at step 30 that the cache can accommodate the write, the flow diagram moves to step 36, where the write is written to the cache. The execution of the write operation in the cache results in the write operation being saved to non-volatile storage in the computer system without the necessity of activating the hard disk drive of the computer system. As such, if the hard disk drive is in a reduced power state (step 28) and if the cache includes space to accommodate the write (step 30), the write is written to flash memory without reactivating the hard disk drive, thereby allowing the hard disk drive to remain in its reduced power state. When the hard disk drive is in a reduced power state, reads and writes to the cache are faster than reads and writes to the hard disk drive. Following step 36, the flow diagram concludes at step 40.

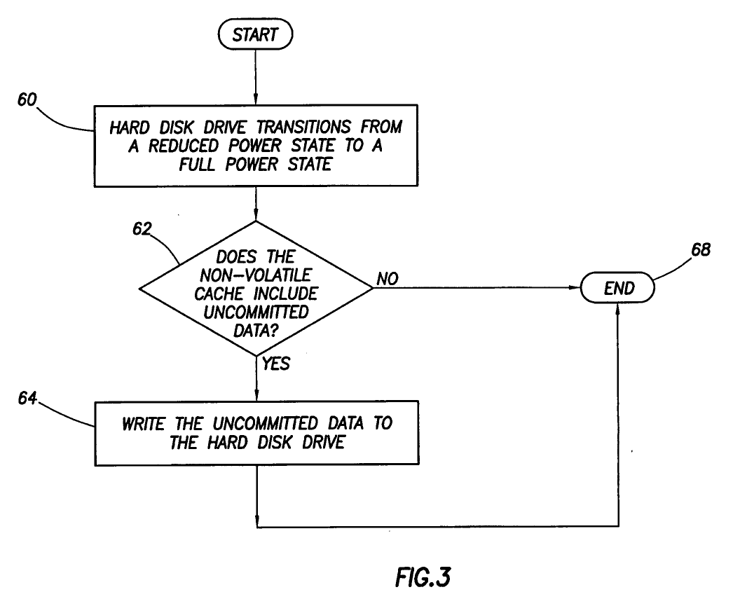

Shown in FIG. 3 are a series of method steps that are performed each time that a hard disk drive transitions from a reduced power state to a full power state. When a hard disk drive transitions from a reduced power state to a full power state, all uncommitted writes in flash memory are written back to the hard disk drive. At step 60, the hard disk drive of the computer system is returned to a full power state from a reduced power state. At step 62, the cache manager determines if the flash memory contains uncommitted writes. If the flash memory includes uncommitted writes, the uncommitted writes are written back to the hard disk drive at step 64 and the process ends at step 68. If the cache does not include uncommitted writes, the process ends at step 68.

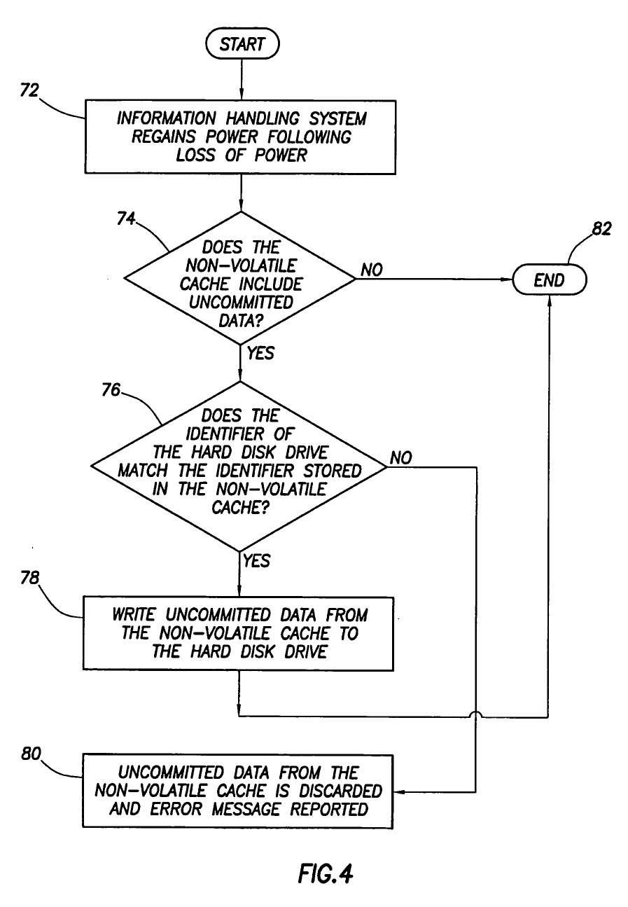

Cache 18 will include for each write stored in the cache, an identifier that identifies the physical hard disk drive that is associated with the write. In this manner, each write is correlated with a unique hard disk drive. Associating each write stored in the cache with a hard disk drive prevents the writes in the cache from being transferred to a hard disk drive that was not intended to receive the write. As an example, the association of each write in the cache to a unique hard disk drive will assist in preventing a write to an unassociated hard disk drive following the swap of hard disk drives in a computer system. Hard disk drives are typically swapped into and out of a computer system while the computer system is powered off. When the computer system is powered back on, all uncommitted writes in the cache are written back to the hard disk drive of the computer system if the writes are associated with the hard disk drive that is installed in the computer system. A flow diagram of this operation is shown in FIG. 4.

At step 72 of FIG. 4, the information handling system or computer system is powered up following a loss of power. Upon power up, the hard disk drive of the computer system will be in a full power state. At step 74, the cache manager determines if the cache includes uncommitted writes. If the cache does not include uncommitted writes, the flow diagram ends at step 82. If the cache does include uncommitted writes, it is determined at step 76 if the uncommitted writes are associated with the hard disk drive installed in the computer system. If the uncommitted writes are associated with the hard disk drive of the computer system, the writes are written back at step 78 to the hard disk drive. If the uncommitted writes of the hard disk drive are not associated with the hard disk drive of the computer system, the writes are not written back to the computer system (step 80). Following a determination that the uncommitted writes of the cache are not associated with the installed hard disk drive, an error message can be communicated to the user, the uncommitted writes can be discarded, or both.

The system and method described herein is advantageous because the cache manager typically copies the data associated with each read to the cache. After a number of reads, the cache is populated with a set of frequently or commonly accessed data, thereby reducing the need for the hard disk drive to be accessed for the reads. Because the hard disk drive is accessed less frequently, the hard disk drive may enter a reduced power state, thereby conserving the power resources of the computer system.

Although the system and method disclosed herein is especially suited for use in a portable or laptop computer system, the system and method disclosed herein is not limited in its application to portable or laptop computers. Rather, the system and method disclosed herein may be used with any information handling system in which it is desirable to reduce the number or frequency of writes transmitted to the hard disk drive of the computer system so that the hard disk drive of the information handling system can be spun down in a power efficient manner that also preserves the storage integrity of the information handling system. Although the present disclosure has been described in detail, it should be understood that various changes, substitutions, and alterations can be made hereto without departing from the spirit and the scope of the invention as defined by the appended claims.

What is claimed is:

1. A method for handling write commands transmitted to a hard disk drive of an information handling system, comprising the steps of:
receiving the write command at a cache memory controller;
determining whether the hard disk drive is in a reduced power state;
transmitting the write command to cache memory if the hard disk drive is in a reduced power state;
wherein cache memory comprises non-volatile flash memory.

2. The method for handling write commands of claim 1, wherein the cache memory controller comprises a software module that is integrated with the operating system of the information handling system.

3. The method for handling write commands of claim 1, wherein the cache memory controller comprises a storage controller associated with the storage of the information handling system.

4. The method for handling write commands of claim 1, further comprising the step of transmitting the write command to the hard disk drive if it is determined at the determining step that the hard disk drive is not in a reduced power state.

5. The method for handling write commands of claim 1, wherein the step of transmitting the write command to cache memory if the hard disk drive is in a reduced power state comprises the steps of:
determining whether the hard disk drive is in a reduced power state;
determining whether the cache memory includes available space for storing the data of the write command; and
transmitting the write command to cache memory if the hard disk drive is in a reduced power state and the cache memory includes available space for handling the write command.

6. The method for handling write commands of claim 5, further comprising the step of transmitting uncommitted data from the cache memory to the hard disk drive if it is determined that the cache memory does not include available space for storing the data of the write command.

7. The method for handling write commands of claim 6, wherein the step of transmitting uncommitted data from the cache memory to the hard disk drive comprises the step of transitioning the hard disk drive from a reduced power state if the hard disk drive is in a reduced power state.

8. The method for handling write commands of claim 7, further comprising the step of transmitting the write command to cache memory following the determination that the cache memory does not include available space for handling the write command and the step of transmitting uncommitted data from the cache memory to the hard disk drive.

9. The method for handling write commands of claim 1, further comprising the steps of:
transitioning the hard disk drive from a reduced power stated to a full power state;
determining whether uncommitted data exists in the cache memory; and
writing the uncommitted data to the hard disk drive.

10. The method for handling write commands of claim 1, wherein each entry in the cache memory includes an identifier that associates the entry with the hard disk drive to which the write command was directed.

11. The method for handling write commands of claim 10, further comprising the steps of:
transitioning the hard disk drive from a reduced power stated to a full power state;
determining whether uncommitted data that is associated with the hard disk drive exists in the cache memory; and
writing the uncommitted data that is associated with the hard disk drive to the hard disk drive.

12. A method for routing a write command to storage in a computer system, comprising the steps of:
receiving the write command at a cache manager module, wherein the cache manager module is integrated with the operating system of the computer system;
determining whether the hard disk drive of the computer system is in a reduced power state;
routing the write command to the hard disk drive is the hard disk drive is not in a reduced power state; and
routing the write command to a non-volatile flash memory if the hard disk drive is in a reduced power state.

13. The method for routing a write command to storage in a computer system of claim 12, wherein the step of routing the write command to flash memory if the hard disk drive is in a reduced power state comprises the steps of:
determining if the flash memory includes space for storing the data of the write command; and
writing the data of the write command to the flash memory if the flash memory includes space for storing the data of the write command.

14. The method for routing a write command to storage in a computer system of claim 13, further comprising the step of writing all uncommitted data to the hard disk drive if it is determined that the flash memory does not include space for storing the data of the write command.

15. The method for routing a write command to storage in a computer system of claim 14, wherein the step of writing all uncommitted data to the hard disk drive comprises the step of transitioning the hard disk drive from its reduced power state.

16. The method for routing a write command to storage in a computer system of claim 15, further comprising the step of writing the data of the write command to the flash memory following the step of writing all uncommitted data to the hard disk drive following a determination that that the flash memory does not include space for storing the data of the write command.

17. A method for routing a write command to storage in a computer system, comprising the steps of:
receiving the write command at a cache manager, wherein the cache manager is associated with a storage controller of the computer system;
determining whether the hard disk drive of the computer system is in a reduced power state;
routing the write command to the hard disk drive is the hard disk drive is not in a reduced power state; and
routing the write command to a non-volatile flash memory if the hard disk drive is in a reduced power state.

18. The method for routing a write command to storage in a computer system of claim 17, wherein the step of routing the write command to flash memory if the hard disk drive is in a reduced power state comprises the steps of:
determining if the flash memory includes space for storing the data of the write command; and
writing the data of the write command to the flash memory if the flash memory includes space for storing the data of the write command.

19. The method for routing a write command to storage in a computer system of claim 18, further comprising the step of writing all uncommitted data to the hard disk drive if it is determined that the flash memory does not include space for storing the data of the write command.

20. The method for routing a write command to storage in a computer system of claim 19, wherein the step of writing all uncommitted data to the hard disk drive comprises the step of transitioning the hard disk drive from its reduced power state.

21. The method for routing a write command to storage in a computer system of claim 20, further comprising the step of writing the data of the write command to the flash memory following the step of writing all uncommitted data to the hard disk drive following a determination that that the flash memory does not include space for storing the data of the write command.
